(19) United States
(12) Patent Application Publication
(10) Pub. No.: US 2009/0218157 A1
(43) Pub. Date: Sep. 3, 2009

(54) Radar Deployed Fender Air Bag

(76) Inventor: David Rammer, Sheboygan, WI (US)

Correspondence Address: MICHAEL I KROLL, 115 Eileen Way, Suite 105, SYOSSET, NY, 11791, US

(21) Appl. No.: 12/039,605

(22) Filed: Feb. 28, 2008

(51) Int. Cl. B60K 28/10

(52) U.S. Cl. 180/271

(57) ABSTRACT

An air bag deployment system incorporated within a vehicles bumpers that may be deployed prior to impact of a static or dynamic object as determined by radar based proximity and velocity sensors.

### BACKGROUND OF THE INVENTION

1. Field of the Invention

The present invention relates generally to motor vehicles and more specifically, to collision safety equipment for motor vehicles encompassing the incorporation of a plurality of air bags into the body of the vehicle that will automatically deploy when the proximity and/or speed exceeds the threshold of safety and an impending collision is imminent. Preferably, the bags are situated in or near the front and rear bumper with the intent of absorbing some of the force encountered in a collision with static or dynamic objects.

Proximity sensors located in or near the front a rear bumper send signals out and information is obtained to calculate the distance of a static or dynamic object in the path of the vehicle. Additionally, velocity sensors located in or near the front a rear bumper send signals out and information is obtained to calculate of the speed of the dynamic object the path of the vehicle. A control module utilizes the aforementioned data along with the vehicles own speed to determine if unsafe conditions exist.

The control module contains preset criteria for distance requirements at given speeds of the dynamic object and the speed of the car. If the thresholds of safety are exceeded and impact is evident, the air bags are deployed. Else, the system maintains an endless loop of sending, reading, and analyzing data sent from the sensors and vehicle speedometer.

2. Description of the Prior Art

Presently there are, air bag systems incorporated into a vehicle's interior to absorb forces imparted to the vehicle's occupants through inertia of the vehicle as well as prior art of incorporating the air bag system within the front and rear bumpers.

These systems have proven to be very successful in dissipating occupant inertia during collision, but have not addressed vehicle inertia other than incorporating collapsible components.

Therefore, it is felt that a need exists for additional means of dissipating inertial forces to a vehicle prior to impact by incorporating deployable airbags within a motor vehicle's exterior, specially the front and/or rear bumpers.

### SUMMARY OF THE PRESENT INVENTION

A primary object of the present invention is to provide an air bag deployment system for motor vehicles incorporated into one or more bumper.

Another object of the present invention is to provide an air bag deployment system having a plurality of air bags arranged within a front and/or rear bumper.

Yet another object of the present invention is to provide an air bag deployment system having a bumper with a plurality of designated sections that break away upon deployment of the airbags.

Still yet another object of the present invention is to provide an air bag deployment system having a plurality of pressurized gas filled cartridges.

Another object of the present invention is to provide an air bag deployment system having a plurality of proximity and velocity sensors in communication with a control module and the pressurized gas cartridges.

Yet another object of the present invention is to provide an air bag deployment system that upon exceeding a safety threshold causes said control module to trigger the release of the gas into one or more airbags that deploy through one or more of the bumper's break away sections thereby absorbing some portion of the bumper.

Still yet another object of the present invention is to provide an air bag deployment system that deploys prior to impact of a static or dynamic object.

Yet another object of the present invention is to provide an air bag deployment system that can be retrofit to any standard motor vehicle.

Additional objects of the present invention will appear as the description proceeds.

The present invention overcomes the shortcomings of the prior art by providing an air bag deployment system incorporated within a vehicles bumpers that may be deployed prior to impact of a static or dynamic object.

The foregoing and other objects and advantages will appear from the description to follow. In the description reference is made to the accompanying drawing, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawing, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWING FIGURES

In order that the invention may be more fully understood, it will now be described, by way of example, with reference to the accompanying drawing in which:

FIG. 1 is an illustrative view of the present invention;

FIG. 2 is an illustrative view of the present invention;

FIG. 3 is an illustrative view of the present invention;

FIG. 4 is an illustrative view of the present invention in use;

FIG. 5 is an illustrative view of the present invention;

FIG. 6 is an illustrative view of the present invention in use;

FIG. 7 is an illustrative view of the present invention;

FIG. 8 is an illustrative view of the present invention;

FIG. 9 is an illustrative view of the present invention;

FIG. 10 is a block diagram of the system main components;

FIG. 11 is a component interface diagram of the radar air bag system of the present invention;

FIG. 12 is a logic diagram of the radar air bag system of the present invention; and

FIG. 13 is a chart of vehicle stopping distance and user defined independent variables.

### DESCRIPTION OF THE REFERENCED NUMERALS

Turning now descriptively to the drawings, in which similar reference characters denote similar elements throughout the several views, the figures illustrate the Radar Deployed Bumper Air Bag System for Motor Vehicles of the present invention. With regard to the reference numerals used, the following numbering is used throughout the various drawing figures.

| | |
|---|---|
| 10 | Radar Deployed Bumper Air Bag System for Motor |
| | Vehicles of the present invention |
| 12 | air bag equipped motor vehicle |
| 14 | external front air bag |
| 15 | external rear air bag |
| 16 | vehicle “2” |
| 17 | vehicle “3” |
| 18 | static object |
| 20 | front proximity sensor |
| 22 | front velocity sensor |
| 24 | signal |
| 26 | proximity measurement |
| 28 | dynamic object |
| 30 | vehicle direction |
| 32 | rear proximity sensor |
| 34 | rear velocity sensor |
| 36 | stop sign |
| 38 | front bumper |
| 40 | rear bumper |
| 41 | air bag housing compartment |
| 42 | breakaway panel |
| 44 | gas cartridge |
| 46 | control module |
| 48 | speedometer |
| 49 | stopping distance formula |
| 50 | coefficient between tires and road surface |
| 52 | vehicle mass |
| 54 | driver reaction time |
| 56 | minimum velocity of deployment |
| 58 | front surface of 38 |
| 60 | top surface of 38 |
| 62 | bottom surface of 38 |

### DETAILED DESCRIPTION OF THE PREFERRED EMBODIMENT

The following discussion describes in detail one embodiment of the invention (and several variations of that embodiment). This discussion should not be construed, however, as limiting the invention to those particular embodiments; practitioners skilled in the art will recognize numerous other embodiments as well. For definition of the complete scope of the invention, the reader is directed to appended claims.

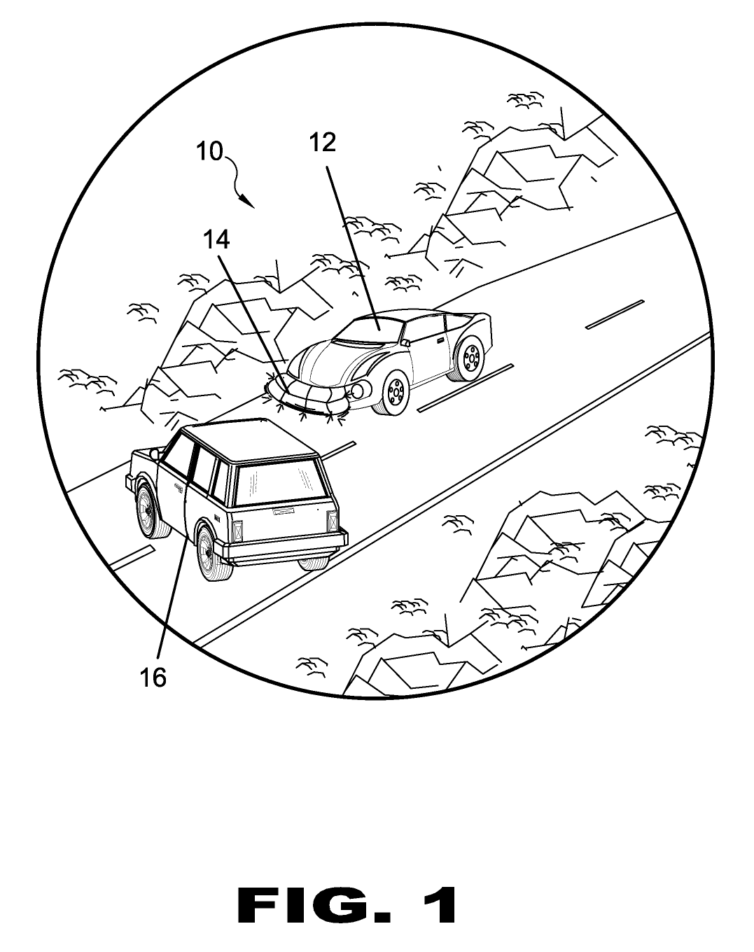

FIG. 1 is an illustrative view of the present invention 10 in use. Shown is the present invention 10, an air bag system for front and rear vehicle bumpers comprising an air bag compartment housing a plurality of air bags integrally incorporated within a vehicle bumper having proximity and velocity sensors in communication with gas cartridges. Depicted is the approaching air bag equipped vehicle's 12 front air bags 14 deployed prior to impact with disabled vehicle “2” 16. The air bag system 10 includes a control module that analyzes data sent from the vehicles speedometer and the bumper mounted proximity sensors and velocity sensors. The aforementioned data is compared to preset thresholds of unsafe or impact probabilities. If the thresholds are exceeded, the air bags 14 are deployed.

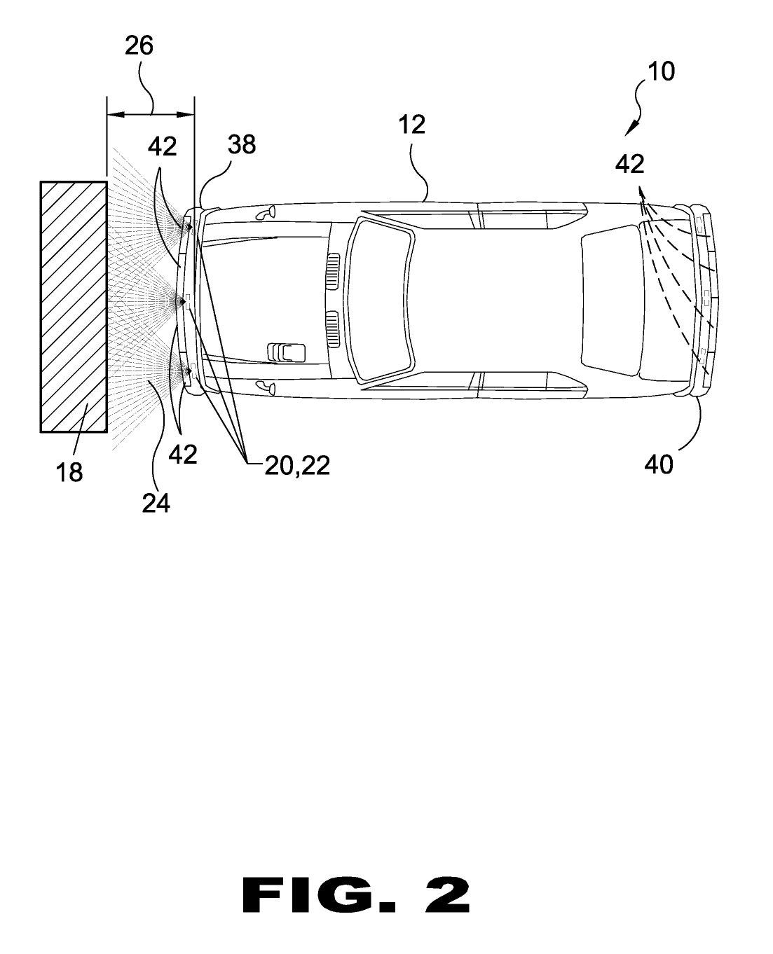

FIG. 2 is an illustrative view of the present invention 10. Shown is the air bag system 10 in conjunction with a static object 18. The proximity 20 and velocity 22 radar sensor transceivers send signals 24 that are returned and interpreted by a control module that in turn determines if the speed of the equipped vehicle 12 and the proximity measurement 26 of the static object 18 warrants deployment of the airbags. Airbags are installed in compartments with breakaway panels 42 in both the front 38 and rear 40 bumper.

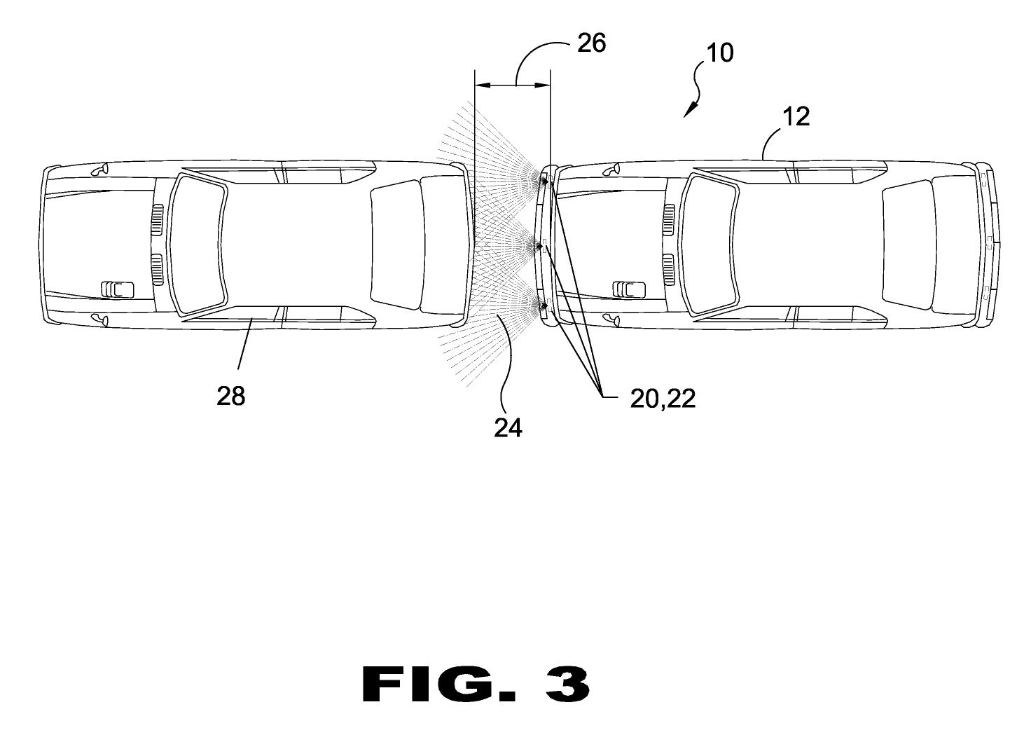

FIG. 3 is an illustrative view of the present invention 10. Shown is the air bag system 10 in conjunction with a dynamic object 28. The proximity 20 and velocity 22 sensors send signals 24 that are interpreted by a control module that in turn determines if the speed of the equipped vehicle 12 and the proximity measurement 26 of the static object 28 warrants deployment of the airbags.

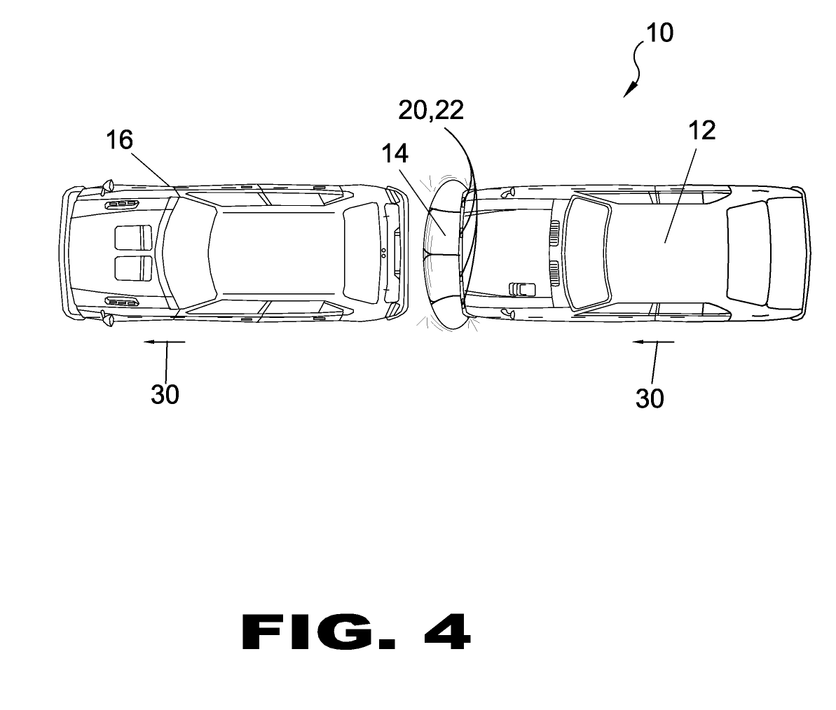

FIG. 4 is an illustrative view of the present invention 10 in use. Shown is the air bag system 10 with front bumper air bags 14 deployed. The proximity 20 and velocity 22 sensors sent readings to a control module and it was determined the proximity between the equipped vehicle 12 and vehicle “2” 16 as well as the velocity of each exceeded the threshold of safety. As a result, the front bumper airbags 14 were deployed.

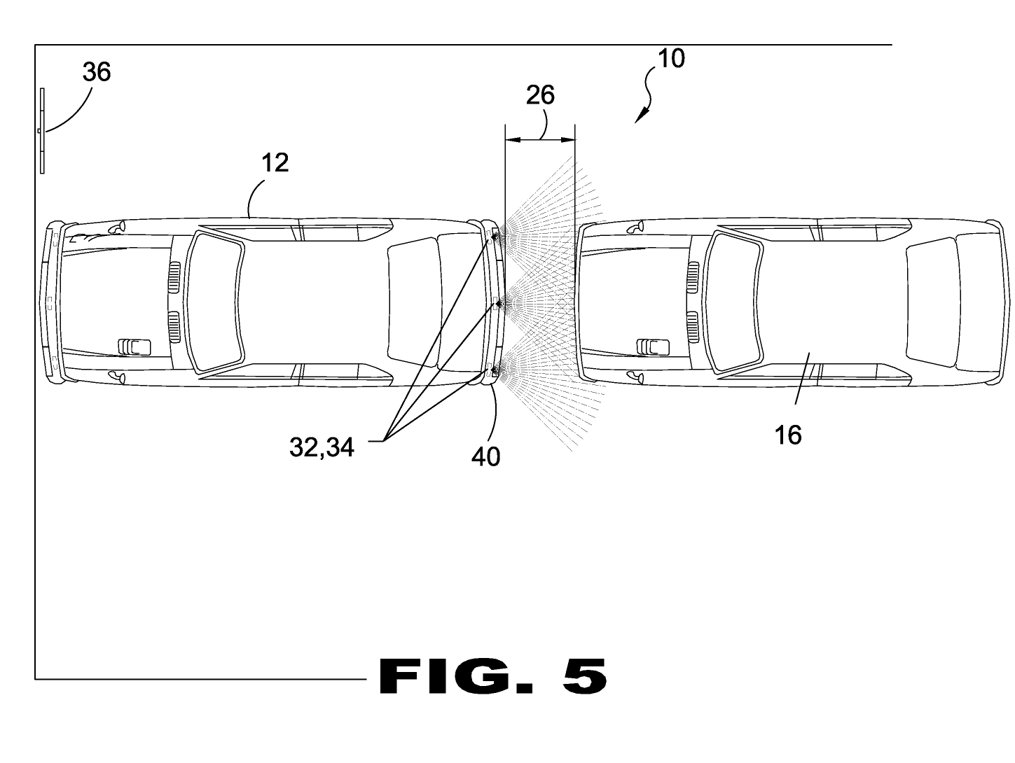

FIG. 5 is an illustrative view of the present invention 10. As illustrated a stationary air bag equipped vehicle 12 is at a stop sign 36 with the air bags in the rear bumper 40 along with radar proximity 32 and velocity 34 sensors so the control module calculates how fast the approaching vehicle “2” 16 is traveling along with a proximity measurement 26 to determine when to deploy the airbag prior to impact.

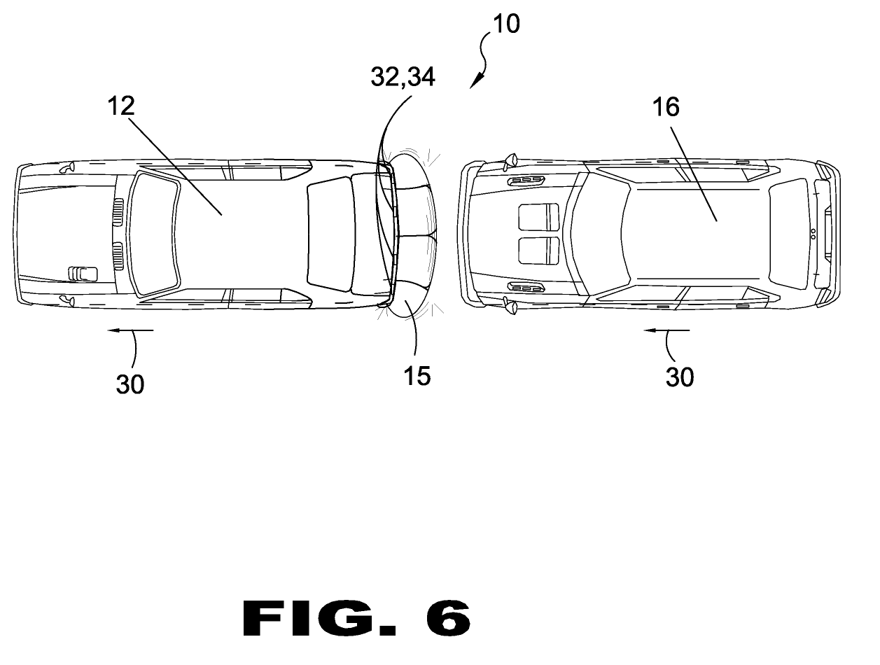

FIG. 6 is an illustrative view of the present invention 10 in use. Shown is the air bag system 10 with rear bumper air bags 15 deployed. The rear proximity 32 and velocity 34 sensors sent readings to a control module and it was determined the proximity between the equipped vehicle 12 and vehicle “2” 16 as well as the velocity of each exceeded the threshold of safety. As a result, the rear bumper airbags 15 were deployed. The arrows indicate the direction 30 of the respective vehicles.

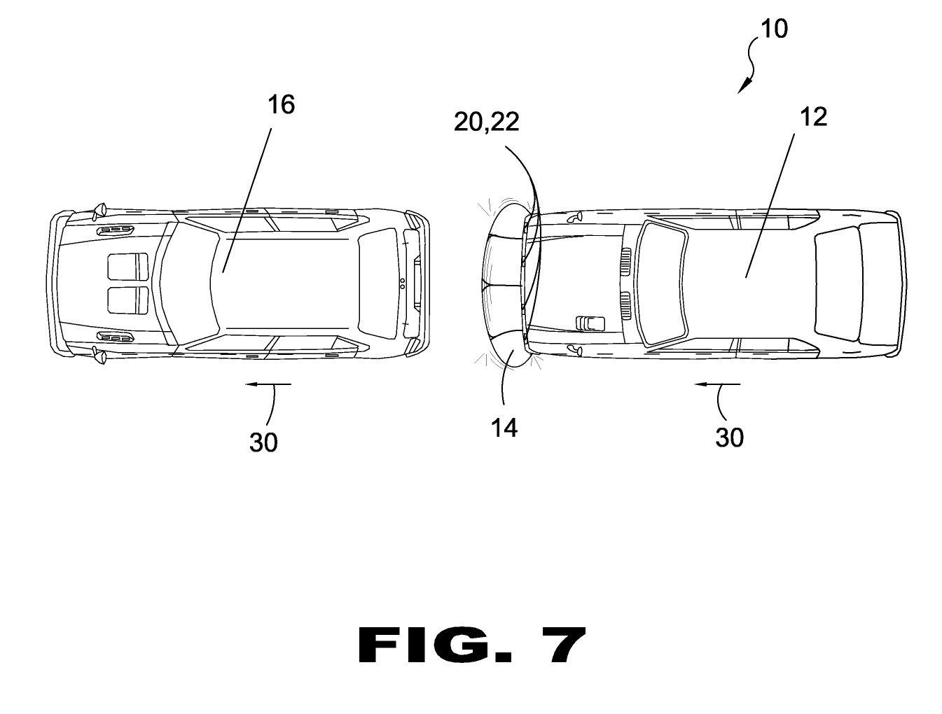

FIG. 7 is an illustrative view of the present invention 10 in use. Shown is the air bag system 10 with front bumper air bags 14 deployed. The front proximity 20 and velocity 22 sensors sent readings to a control module and it was determined the proximity between the equipped vehicle 12 and vehicle “2” 16 as well as the velocity of each exceeded the threshold of safety. As a result, the front bumper airbags 14 were deployed. The arrows indicate the direction 30 of the respective vehicles.

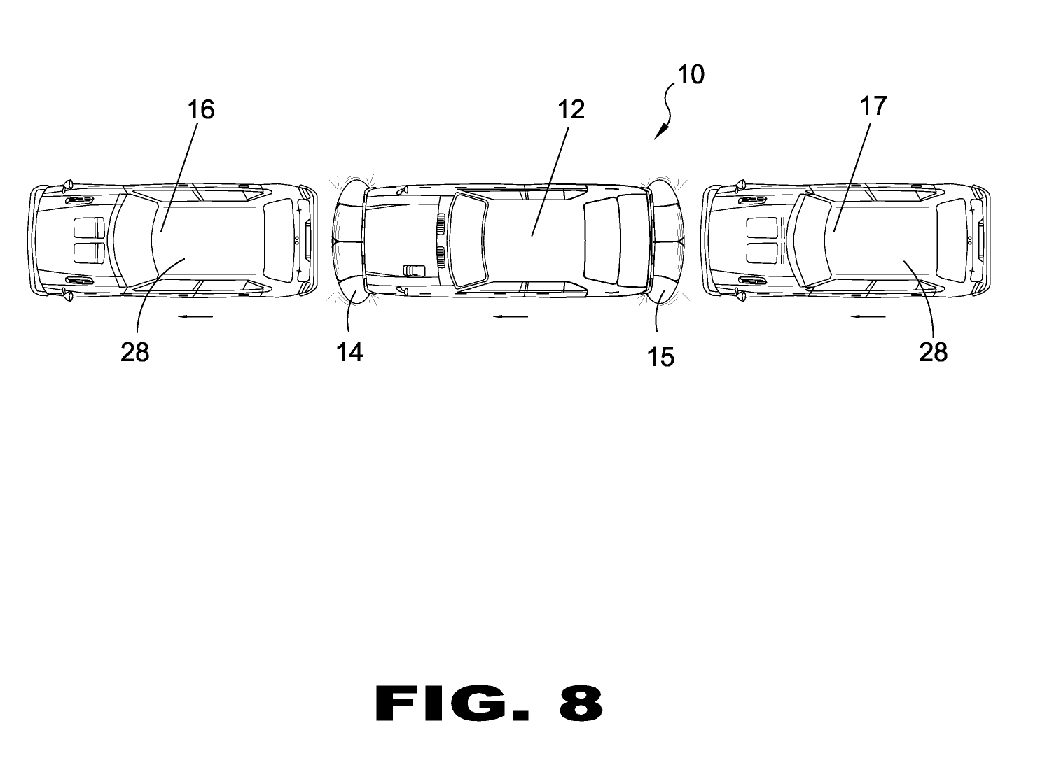

FIG. 8 is an illustrative view of the present invention 10. Shown is the air bag system 10 in conjunction with a dynamic object 28 detected by both the front and rear bumper sensors of the equipped vehicle 12. In the event of both bumper sensors detecting conditions exceeding the threshold of safety, both the front air bags 14 and rear bumper airbags 15 were deployed to absorb the impact of dynamic vehicle “2” 16 and dynamic vehicle “3” 17.

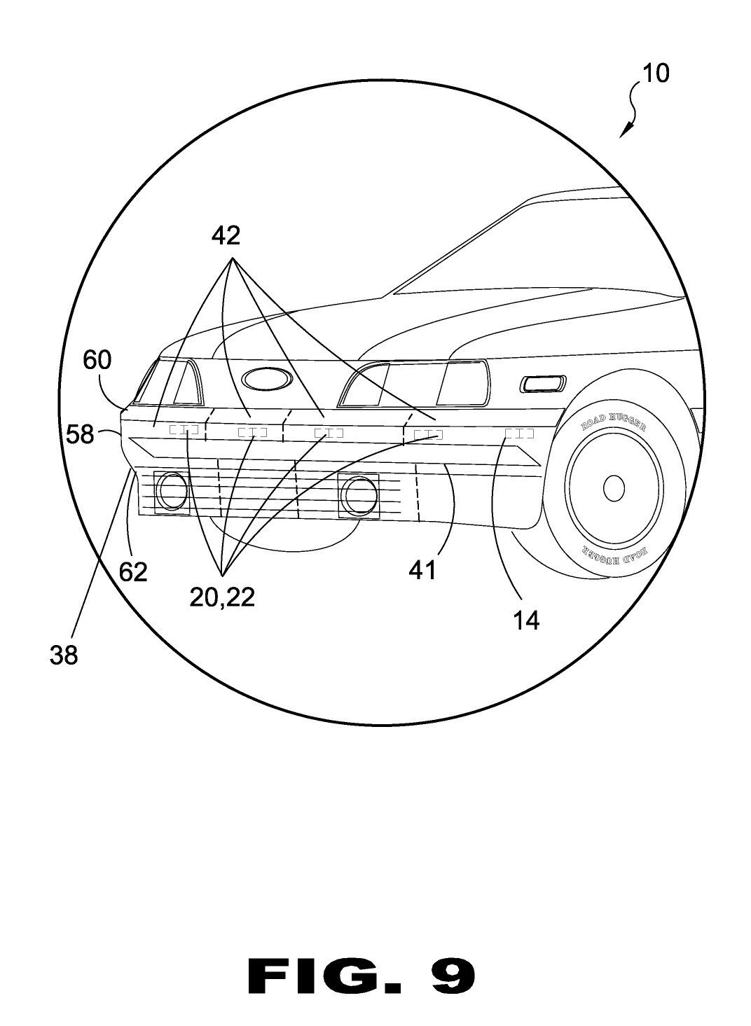

FIG. 9 is an illustrative view of the present invention 10. Shown is the air bag system 10 for front and rear vehicle bumpers comprising an air bag housing compartment 41 with a plurality of breakaway panels 42 that are blown out upon deployment due to the force of the inflation of the air bags 14. Shown are the air bags 14 within the airbag compartment 41 positioned in the ideal location in order to perform the function required. Also shown is the interrelation between the proximity 20 and velocity 22 sensors of the front bumper 38.

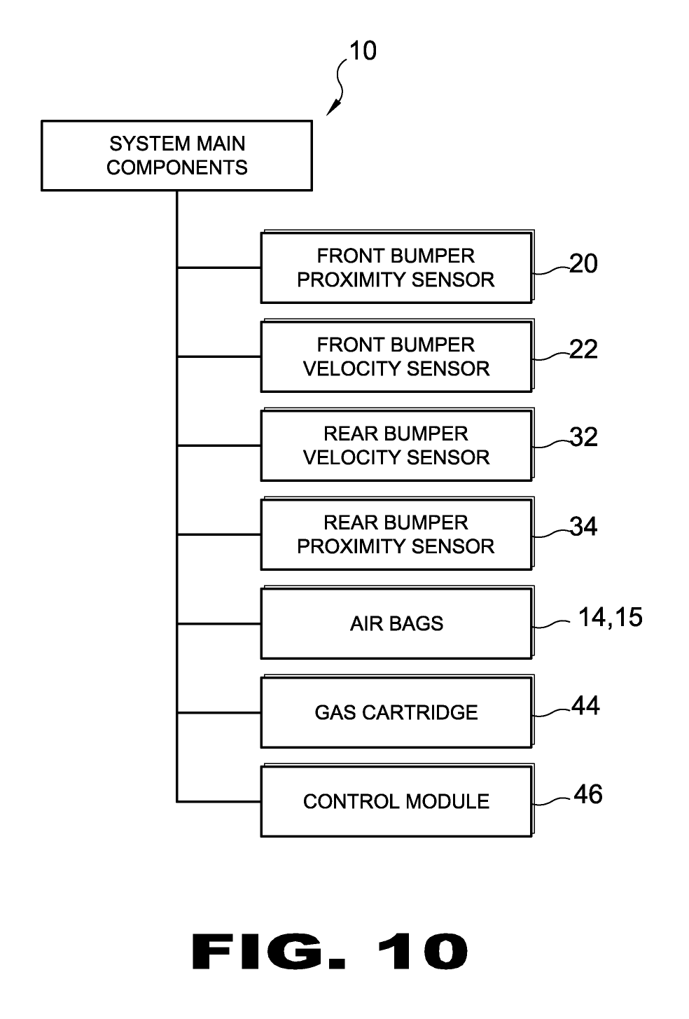

FIG. 10 is a block diagram of the system main components of the present invention 10. The air bag system 10 comprises front proximity 20 and velocity sensors 22, rear proximity 32 and velocity 34 sensors and a control module 46 to activate gas cartridges 44 to deploy the air bags 14,15 in the event that threshold of safety is in violation.

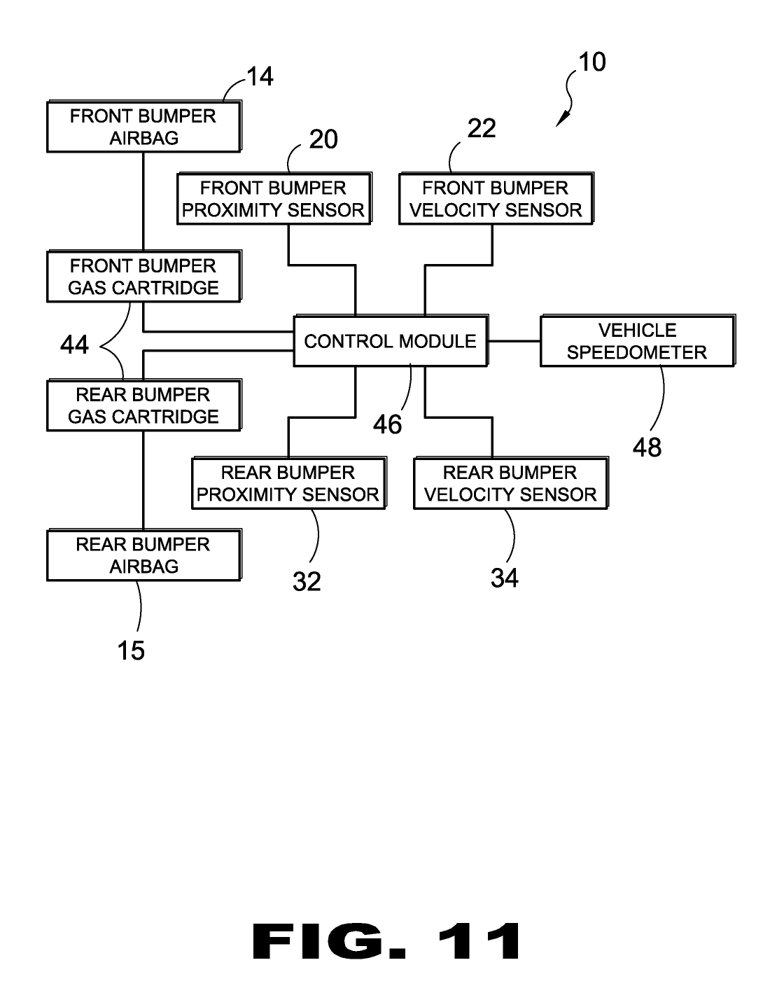

FIG. 11 is a component interface diagram of the radar air bag system of the present invention 10. The control module 16 processes data collected from the vehicle speedometer 48, front bumper proximity sensor 20, front bumper velocity sensor 22, rear bumper proximity sensor 32 and the rear bumper velocity sensor 34 to determine if the threshold of safety is in violation and, if so, activates the appropriate gas cartridge 44 to deploy the front 14 and/or rear 15 air bags.

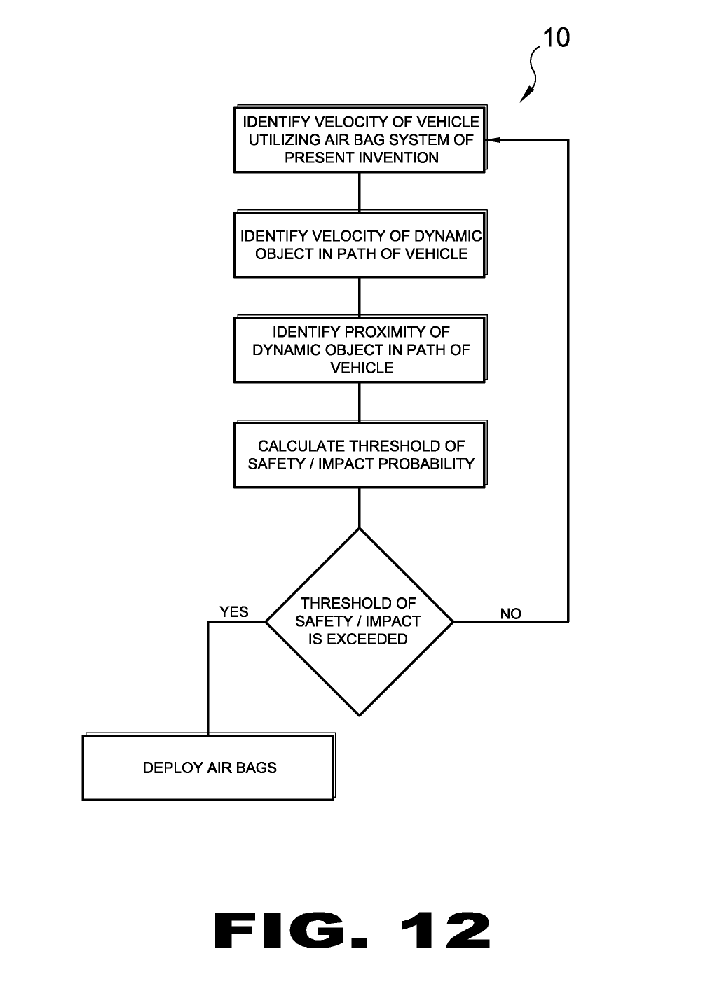

FIG. 12 is a logic diagram of the radar air bag system of the present invention 10. The air bag system for front and rear vehicle bumpers utilizes a control module to analyze data sent from the vehicles speedometer and the bumper mounted radar proximity sensors and velocity sensors. The aforementioned data is compared to preset thresholds of unsafe or impact probabilities. If the thresholds are exceeded, the air bags are deployed. Else, the system maintains an endless loop of sending, reading, and analyzing data sent from the sensors and speedometer.

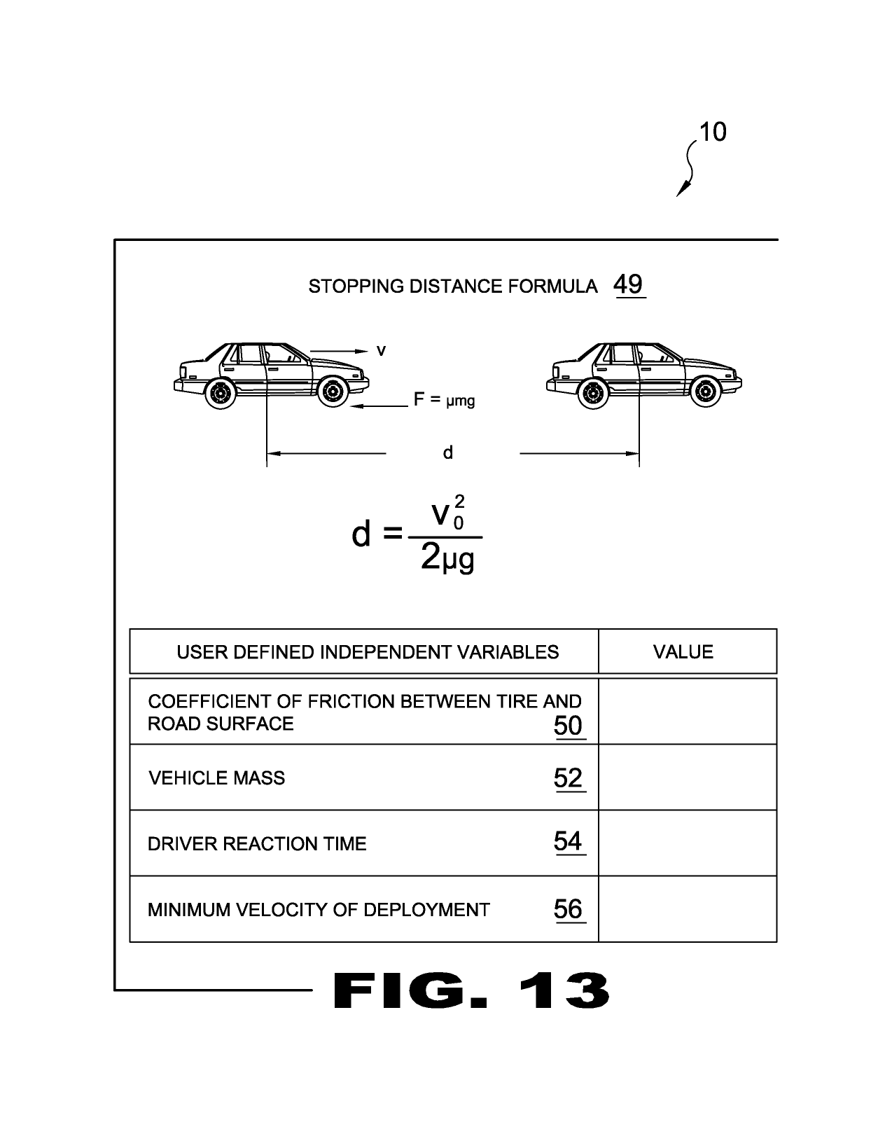

FIG. 13 is a chart of vehicle stopping distance and user defined independent variables of the present invention 10. The air bag system control module is programmed to suit individual needs of the user and characteristics of the vehicle being equipped. A stopping distance formula 49 is used to determine when deployment of the air bags is required by factoring the coefficient of friction between tire and road surface 50, vehicle mass 52, driver reaction time 54, and minimum velocity of deployment 56. These aforementioned user defined settings in addition to the standard formula for stopping distance of the vehicle allow the control module to determine deployment of the air bags.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims.

1. A pre-impact external air bag deployment system incorporated in the bumper of a motor vehicles comprising:
a) a bumper on a motor vehicle, said bumper having a rear surface, a front surface, a top surface, and a bottom surface, said front surface having a convex outer portion adjacent said top surface, said convex outer portion curving downwardly to a reduced thickness of said bumper in a lower portion thereof;
b) at least one compartment integral with said bumper located behind said convex outer portion;
c) an air bag disposed within said compartment;
d) a breakaway panel in said bumper corresponding with said air bag compartment, said breakaway panel formed in a leading edge of said convex outer portion;
e) a gas cartridge for said air bag to provide inflation means when deployment is required, said gas cartridge being located directly behind said air bag;
f) at least one proximity sensor transceiver to send and receive a radar signal to provide data regarding the distance of a static or dynamic object;
g) at least one velocity sensor transceiver to send and receive a radar signal to provide data regarding the speed of travel of a static or dynamic object;
h) a vehicle speedometer; and
i) a control module in communication with said proximity sensor, said velocity sensor, said speedometer and said gas cartridge.

2. The pre-impact external air bag deployment system recited in claim 1, wherein said bumper contains a plurality of air bags including one in each corner.

3. The pre-impact external air bag deployment system recited in claim 2, wherein said velocity sensors and said proximity sensors collect data regarding the distance and speed of an approaching object and send said data to said control module.

4. The pre-impact external air bag deployment system recited in claim 3, wherein said control module analyzes said data against the recorded speed from said speedometer to determine if the distance and speed of the approaching object is within a pre-defined threshold of safety.

5. The pre-impact external air bag deployment system recited in claim 4, wherein determination of a breach of the threshold of safety is detected, said control module activates said gas cartridges.

6. The pre-impact external air bag deployment system recited in claim 5, wherein activation of said gas cartridges inflates the corresponding air bags.

7. The pre-impact external air bag deployment system recited in claim 6, wherein inflation of said air bags compromises and knocks out said breakaway panels and said air bag is deployed therethrough from said compartment.

8. The pre-impact external air bag deployment system recited in claim 7, wherein said air bags, proximity sensors and velocity sensors are disposed in both front and rear bumpers.

9. The pre-impact external air bag deployment system recited in claim 4, wherein said threshold of safety is determined by a plurality of user defined independent variables.

10. The pre-impact external air bag deployment system recited in claim 9, wherein said user defined independent variables include:
a) coefficient of friction between tire and road surface;
b) vehicle mass;
c) driver reaction time; and
d) minimum velocity of deployment.

11. The pre-impact external air bag deployment system recited in claim 7, wherein deployment of said air bags absorb impact of the imminent collision thereby reducing damage to said vehicle and risk of injury to and occupants therein.

12. The pre-impact external air bag deployment system recited in claim 1, wherein said system can be retrofit to existing standard motor vehicles.
